(19) United States
(12) Patent Application Publication
(10) Pub. No.: US 2015/0363895 A1
(43) Pub. Date: Dec. 17, 2015

(54) SYSTEM AND METHOD FOR MANAGING ONLINE INFORMATION BY A COMMUNITY MANAGER

(71) Applicant: NETWORK ACTIVATOR LTD., Raanana (IL)

(72) Inventor: Adam ZAWEL, Raanana (IL)

(21) Appl. No.: 14/764,614

(22) PCT Filed: Feb. 3, 2014
(86) PCT No.: PCT/IB14/58752

§ 371 Date: Jul. 30, 2015

Related U.S. Application Data
(60) Provisional application No. 61/760,184, filed on Feb. 4, 2013.

(51) Int. Cl. G06Q 50/00; G06Q 10/00

(52) U.S. Cl. CPC G06Q 50/01; G06Q 10/00

(57) ABSTRACT

The present invention defines, integrates, and simplifies the work processes for online moderating. The present invention simplifies the work processes for online community management, including website forwarding, and social middleware—specifically, the insertion of user generated content into business applications. The system enables the user to capture website information efficiently, add value by classifying and commenting on that information and forward the information using pre-formed message template to individuals, groups and other applications. The system may have varying degrees of automation depending on the implementation requirement, leaving the human community manager to efficiently focus only on what requires human judgment.

### FIELD OF THE INVENTION

The present invention generally relates to the field of online information management. More particularly, the present invention relates to online information forwarding, online community management and social middleware.

### BACKGROUND OF THE INVENTION

Organizations and their employees collect information on the Internet for a variety of reasons. In particular, with the advent of social networks, companies are constantly “listening” to online feedback, in an effort to understand what their customers are saying so that they can then utilize that information. Companies are also listening and responding to what their own employees are saying on internal, private intranet forums.

The employees, whose job it is to monitor and act on information on web pages and social networks, known as “community managers” or “moderators”, are often overwhelmed with the volume of information and the tasks that should be completed in relation this online activity.

The most basic job for a community manager is to participate directly in online discussions. He may “Like” an item, or respond to it online himself.

However, community managers quickly learn that they cannot address all issues themselves, and there are some things that are “said” in forums that should be shared with others in the organization and the community. This sharing happens with the posting itself, but the community manager may want to highlight the comments within the social network, or to people outside the social network. In many communities, this action of identifying interesting content and sharing it with the right people is the most important action of the community manager. However, it is not easy to do.

On an ad-hoc basic, community managers will notify others in his organization about the information on the web, such as an interesting forum discussion that mentions the company name, for example. The community manager may even copy an item found on the web and paste in into a knowledge management system at the company. For example, if the community manager discovered some interesting information from a competitor, this knowledge should be made available to the company's management.

These tasks of capturing information, analyzing and adding value to the information, and intelligently forwarding the information to people or other business applications, for example, should be carried out more often by the community managers. However, there are obstacles in the way:

1. Lack of Knowledge:
The community managers, especially if they are new to the company, don't know have good guidance from the more experienced people at the company about what to do with the information.

2. No approved workflow
The organization has not “empowered” the community managers to pass on this information from social discussions so that the information has a real impact on the organization.

3. Lack of Time:
It is a hassle to copy information from a website, open email or an email marketing application to set up a mailing, record the activity in a third application that keeps track of the community manager's activities, for example.

The current invention tackles these problems above by providing guidance to the community managers regarding the workflow (the suggested “capture/add value/forward” activities), allowing the organization to build this workflow, and making the community managers more efficient.

Some challenges associated with online community management are known in the art. For example:

U.S. Pat. No. 7,865,590 entitled “Community Based Moderation in Online Sessions” describes the reporting on inappropriate behavior.

U.S. Pat. No. 8,280,872, entitled “Automated Routing of Forum Postings” and U.S. Pat. No. 5,909,679 “Knowledge-based community manager for electronic mail help lists”, refers to “Inviting the right person to answer a question from a forum”.

U.S. Pat. No. 7,197,470 entitled “System and method for collection analysis of electronic discussion methods” describes “methods for analyzing online discussions”.

U.S. Pat. No. 7,702,735, relates to forum posting and specifies how postings may appear differently to different users of a social network, based on the security concerns or preferences of the poster.

These patents above relate to improving the inherent functioning of the social network itself, empower the community members to “self-police” and to route the right content to people in a social network (or online community), so that the community is active, and questions are answered.

In some online communities—the automatic functioning of the social network is enough to make the community vibrant and “successful.” But with other communities, especially when some members are reluctant to participate (perhaps because they are new to social networking, or are too busy), the extra encouragement of the community manager, in the form of “personalized” outreach is needed. This outreach of the community manager, and his process, is the impetus for the current invention.

To inspire his community, the community manager may need to pull information into the network from sources, such as websites, that are outside the social network. Also, community managers need to reach out to people outside the network or using channels, such as email, that are outside the social network. Existing prior art refers to methods that must be ‘embedded inside’ social networks.

Prior art patents describe “matchmaking” and automatic invitations to join conversations based on profiles. However, prior art does not describe the efficient capturing of content posted anywhere on the Internet, including web pages of social networks where the detailed profile of the person making the comment cannot be readily evaluated.

Within the overall method of managing web content, there is particular emphasis on the tailored forwarding of web content to groups, and the ability to customize the messages to members of the group.

Specific needs for tailoring and customizing email messages are described in U.S. Pat. No. 7,747,692, which relates to the need to tailor, produce and process a message for specific classes of recipients. U.S. Pat. No. 8,099,465 refers to email messages sent to multiple parties.

U.S. Pat. No. 6,816,887, entitled “Method and apparatus for sending private messages within a single electronic message”, describes “Methods for efficiently sending messages to groups”.

While this prior art refers to efficiently sending emails to groups of people, the current invention introduces new elements by marrying group messaging features to social networking and web content. For example, when a community member captures content from outside a social network, and sends it into the social network, he can then customize the appearance of the message for some members, based on attributes in their profiles.

There is thus a need for a more efficient and comprehensive system for managing the broad set of tasks that a community managers needs to carry out when faced with a piece of online information.

### SUMMARY OF THE INVENTION

The present invention relates to a method and a system that makes the job of online moderating and community management easier and more effective. The present invention defines, integrates, and simplifies the work processes for online moderating.

The present invention allows the human community manager to review, override, and add comments and value on top of the automated suggestions, regardless of an algorithm. This present invention may be described as “sitting on top of” (in contrast to ‘embedded within’) social networks.

In addition to automatically suggesting that people answer questions within forums, the community manager may manually initiate a “forward” action and suggest that people answer the question or participate in the forum.

Specifically, the present invention enables the user to 1) capture website information efficiently, 2) add value by classifying and commenting on that information, and 3) forward the information using pre-formed message templates to individuals, groups and other software applications, such as a customer management application or a content aggregations application, for example. The present invention may have varying degrees of automation depending on the implementation requirement, leaving the human community manager to efficiently focus only on what requires human judgment

The method of the present invention organizes and integrates a collection of recommended processes that enables the “human touch” of community managers when necessary, but automates portions of the system. The particular business goals and other technology in place in a given implementation, will determine the role of the community manager.

There is thus provided a method for managing online information by a community manager. The method includes the steps of:

capturing information from an online source;

adding value to the information; and

forwarding the information together with the added value.

Furthermore, the step of forwarding may include the step of using pre-formed message templates to forward to any of a group including at least one individual, at least one other community manager, at least one newsletter, at least one content, collecting repository and at least one software application.

Furthermore, the step of adding value includes the steps of classifying, adding tags and commenting on the online information.

Furthermore, the method may include the steps of tracking and reporting the activity of the community manager.

Furthermore, the step of capturing information may be triggered by activity on the web page. The activity that triggers the capture of information may include reaching a certain number of views or comments.

Furthermore, the step of forwarding may include the step of creating reports. The reports may include at least one of a group of reports including ideas developed by community, reputational issues, and the number of sales leads forwarded by the community manager

Furthermore, the steps of capturing, adding value and forwarding may be partially or fully automated.

Furthermore, the step of capturing information may include the steps of adding the website Uniform Resource Locator (URL) address to a watch list and/or storing the information. The step of capturing information may include the steps of capturing the name or unique identification of the author of the content and looking up related information associated with the author in a database.

Furthermore, the method may further include the steps of the community manager launching a software application and uploading a database of members.

Furthermore, the method may further include the steps of the community manager scanning online activity sites; and selecting text from information appearing on the online activity sites.

Furthermore, the step of forwarding may include the step of selecting individuals from within a database who will receive the information together with the added value.

Furthermore, the website information is an online forum message appearing on a message board and further includes the steps of editing the message and forwarding the message back into the message boards or to another activity stream or to an email. The step of editing includes at least one of the steps of adding commentary and adding tags to content to the message.

Furthermore, the method may further include the step of the community manager intervening in the at least partially automated system. The intervention includes at least one of steps of approving, editing and rerouting information.

Furthermore, the method may further include the step of the at least partially automated system learning from the step of intervening and amending its decision making process.

Additionally, there is provided a method for managing online information by a plurality of community managers includes the steps of:

each of the plurality of community managers performing at least one activity on at least one online source;

analyzing the at least one activity by each of the plurality of community managers; and

preparing a report based on the step of analyzing.

Furthermore, the step of performing at least one activity includes the steps of capturing information from a website or social media page; adding value to the information; and forwarding the information together with the added value using pre-formed message templates to any of a group including at least one individual, at least one other community manager, at least one newsletter, at least one content collecting repository and at least one software application.

### BRIEF DESCRIPTION OF THE DRAWING

The present invention will be understood and appreciated more fully from the following description taken in conjunction with the appended drawings in which:

FIG. 1 is a schematic flow chart illustration of the basic system architecture of the method for managing online information, constructed and operative in accordance an embodiment of the invention;

FIG. 2 is a schematic flow chart illustration of options available to the community manager using the method of FIG. 1;

FIG. 3 is a schematic flow chart illustration of the personalizing message wizard options available to the community manager using the method of FIG. 1;

FIG. 4 is a schematic exemplar illustration of the application using the method of FIG. 1;

FIG. 5 is a schematic illustration of a web page showing the selection of recipients for receiving a personalized message; and

FIG. 6 is a schematic illustration of a web page showing personalized message of FIG. 5.

### DESCRIPTION OF THE INVENTION

The present invention provides a system and method for online moderation of website forums. The system puts the pieces together so that the community manager is optimally efficient.

The present invention is different from known prior art in that it is a comprehensive system for managing a broad set of tasks that a community managers needs to carry out when faced with a piece of content online. Furthermore, present invention automates the processes that complement the “core” social networking technologies, the processes that a human community manager needs to do his job.

The method of the present invention may be considered to comprise three basic elements:

1) Capture

2) Add Value

3) Forward

Capture

When the community manager “spots” something of interest, the system makes it easy for him to capture that information. For example, the community manager may highlight text on a screen and right click to launch the system.

The text (and other information about the webpage and the author of the content) will automatically be captured and the community manager may then “add value” to, and categorize, the captured information before “forwarding” it.

Add Value

The system makes it easy for the community manager to perform actions on the captured information.

The community manager has the opportunity to add his own comments about the information before forwarding it on. If the community manager is trying to encourage another participant to participate in a discussion this ability to easily add a comment is a critical “human” component in online community moderation. Since the community manager will often send the same personalized message (for example, “please respond to this comment”) the system will store message templates for the community manager to select before forwarding the message.

The community manager may also classify the information being forwarded with tags or categories. For example, if the information is being forwarded to a sales application, the community manager may include tags that will be readable by the sales application. Examples of tags include “lead opportunity” and “CustomerName”. If there is a question from an important client, the community manager of a customer care community may tag it as “urgent” leading the comment to be forwarded via special communication channels.

Forward

Once the community manager has captured information about the web site and added value by classifying and commenting on it, he may then forward the information together with the added value. Some examples of where the content may be forwarded in the system include:
Forwarding the information to an individual
Forwarding the information to a group
Forwarding the information to a newsletter
Forwarding to a content collecting repository, that is then passed on to another website or social media page (for example, the company's Facebook page).
Forwarding the information to an enterprise application

For each of these forwarding activities, the community manager may choose from a set of templates, in real-time, thereby saving time.

The list above is not an exhaustive list—the system may incorporate other destinations for the captured content.

The system is also applicable to a system of more than one community manager. When multiple people in an organization are using the system, one central community manager may capture and forward a piece of web content to an assistant community manager who may forward it again. For example, the central community manager (based in the company's headquarters) may forward information to a regional sales manager who may then personalize the message before sending to customers in his region. This “network of community managers” is an effective way of overcoming the challenge that companies may have in supporting their social enterprise initiatives. It is difficult to get a team of employees to support it. One person may have the full-time moderating role (the social media manager, for example), but he then has difficulty rallying others in the organization to participate. The system, which supports a network of community managers, makes it easier to convince people in the organization of the value of becoming part-time community managers. Furthermore, the system supports tracking and reporting thereby to show the contributions made by the many community managers. The method is capable of tracking:
a single issue that has been handled by multiple community managers (this tracking can quickly reveal a product problem, for example, that community managers have observed);
the varied activities of a single community manager; or
the activities associated with a specific group of members, or an individual member, for example.

This three-step method of Capture/Add Value/Forward may be fully or partially automated. The system helps the community manager perform his tasks more efficiently. It is also possible to use this system to create a roadmap for the introduction of more automation to the workflow. For example, an automated process to “spot” and “capture” something of interest, rather than relying on the human community manager, may be incorporated into the system. The specific tasks that an organization chooses to automate versus those tasks left for human judgment are flexible and not fixed in the system. The embodiment below herein below is an exemplar description of only one specific “balance” between automation and human operation.

Reports may be generated by the system to demonstrate the value that the community manager and the social enterprise initiative are bringing to the enterprise, by analyzing the content that the community manager chose to capture, tag and forward.

Unlike the typical social network reports which may include information such as the number of comments and views, for example, the reports enabled by this invention may include specific value-added actions of the community manager, such as the number of sales leads forwarded by the community managers, or reputational issues (online comments about the company that the community manager tags as damaging to the company's reputation). Thus the system not only comprises a community manager “toolkit” but a system for the organization to measure the community managers' work and the strategic effectiveness of the social enterprise initiative.

Reports from a social network may be used in the following way, for example: A report of members who were active and are now inactive (“formerly active”) may be grouped. The system of the present invention would then associate this group with an outreach plan (the plan would include a message template for the community manager to contact the people in this group). The message could be sent automatically without the community manager even reviewing it, or there could be a review capability for the community manager to personalize the message to some (or all) of the recipients.

A series of recommended actions for the community managers, to drive engagement with the community, can be combined to create a step-by-step community engagement program. These steps, individually, and as a whole, can be refined by learning from the results (for example, if a high percentage of quiet members become active again after receiving a certain message from the community manager, that message template will receive points in the learning algorithm).

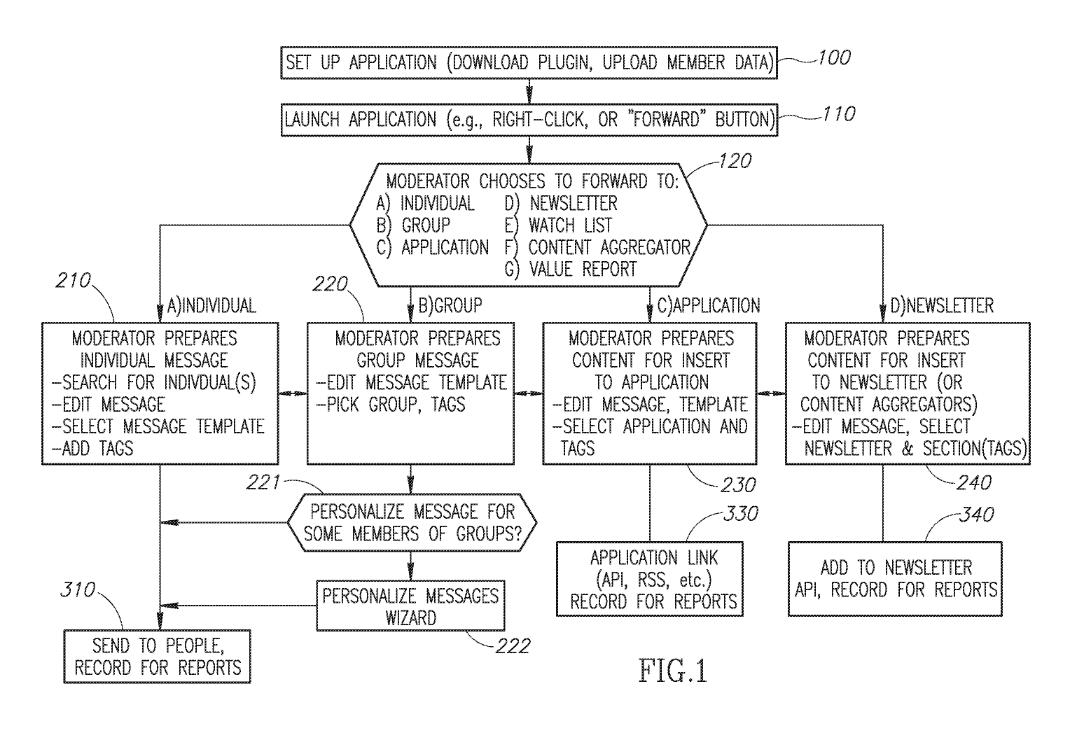

Reference is now made to the various component features of the architecture of the invention shown in FIGS. 1-4. A description of the flow chart process now follows.

### 100 Setup APPLICATION

The community manager (or moderator) may set up the APPLICATION himself (without IT support) by downloading the plugin and uploading contact data. With IT support, he may link the APPLICATION to a database with contact information and profile information for real-time updates. The application may also be integrated with social networks or business applications, so that the user does not need to install it.

### 110 Launch APPLICATION

The community manager, when seeing something of interest on a website or discussion forum, may right-click from a browser or launch the APPLICATION from another system (for example, a social network) that has embedded the APPLICATION launch button. The application may be launched with other plugin-enabled capabilities that are currently, or will be supported by web browsers (for example, voice prompts or gesture recognition)

### 120 Community Manager Chooses to Forward (Query Box)

The launch of the APPLICATION gives the community manager the option to execute a variety of tasks, such as forwarding to an individual (step 210) or a group (step 220), inserting the content into a newsletter or pass onto content aggregator (step 240) or pass the information to another connected application, for example (step 230).

### 210 Community Manager Prepares Individual Message

The community manager may edit the message, search for recipients and add tags/categories for reporting purposes.

### 220 Community Manager Prepares Group Message

The community manager may edit the message, search for and select groups, and add tags/categories.

### 221 Personalize Message for Some Group Members (Yes/No)

If the community manager wants to send a standard message to all group members (query box 221), and customize it he selects “yes” to move to the personalization of the message (step 222).

### 222 Personalize Messages Wizard

The community manager may select which group members should receive customized messages (this process may be completed in a spreadsheet of group members, where the community manager marks the names of group members). He may also deselect group members from receiving the message in this spreadsheet. Then, the wizard takes the community manager through each instance of the message to be customized.

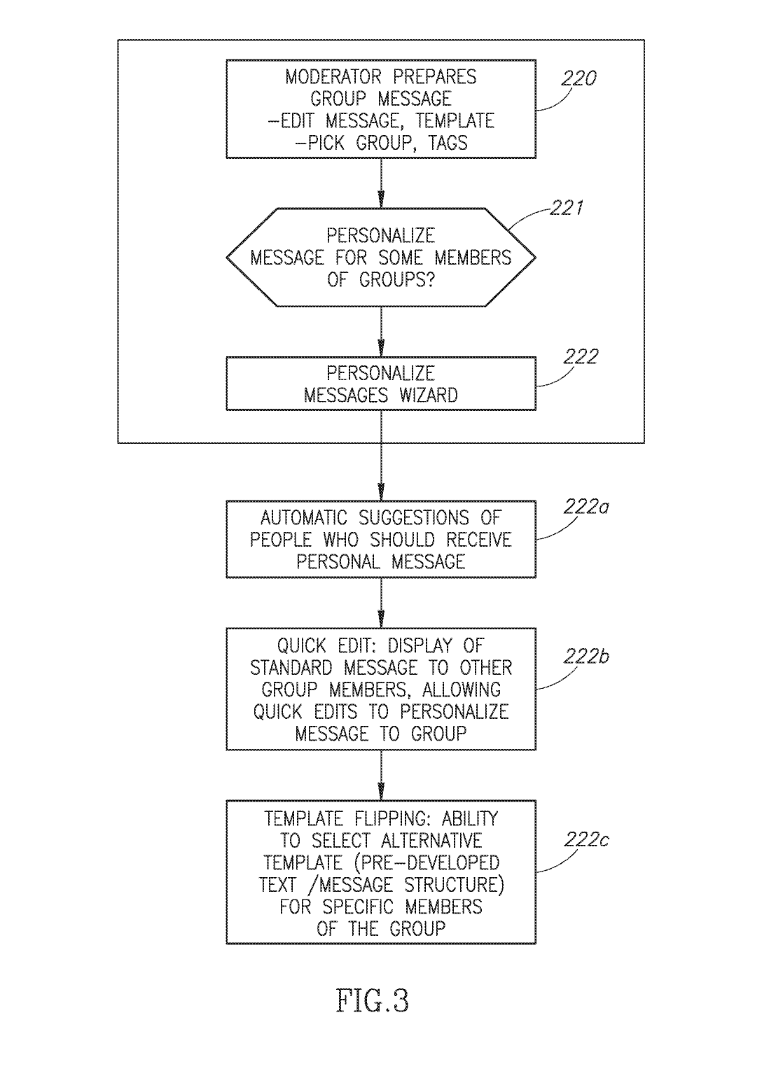

The present invention includes the feature of Personalizing Messages for group members (steps 222; 222a-222c), which are detailed on FIG. 3.

222a: Automatic Suggestions of people who should receive personal message. The member database may have a Yes/No field to indicate if the member has been to an event or has a personal relationship with the community manager. In this case, the wizard will suggest to the community manager to develop a personalized message for this member.

222b: Quick Edit: After the community manager selects the people who will receive personalized emails, the wizard takes the community manager through each instance of the message to be customized (222), the community manager is presented with a copy of the standard message being sent to the group, so he may quickly add edits to personalize the message.

222c: Template Flipping: After the community manager selects a member of the group to receive a different message than the rest of the group, the community manager may select an alternative template (pre-developed text/message structure) for the specific member. So, as the community manager goes through the list of people to receive personalized messages, he may select (flip) the templates being used for each member of the group.

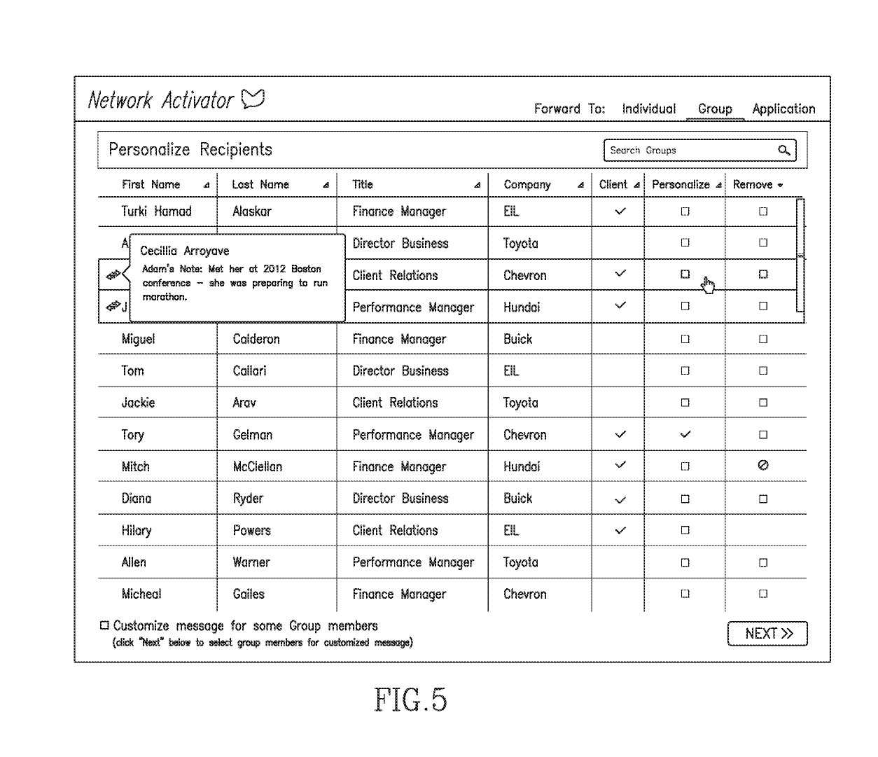

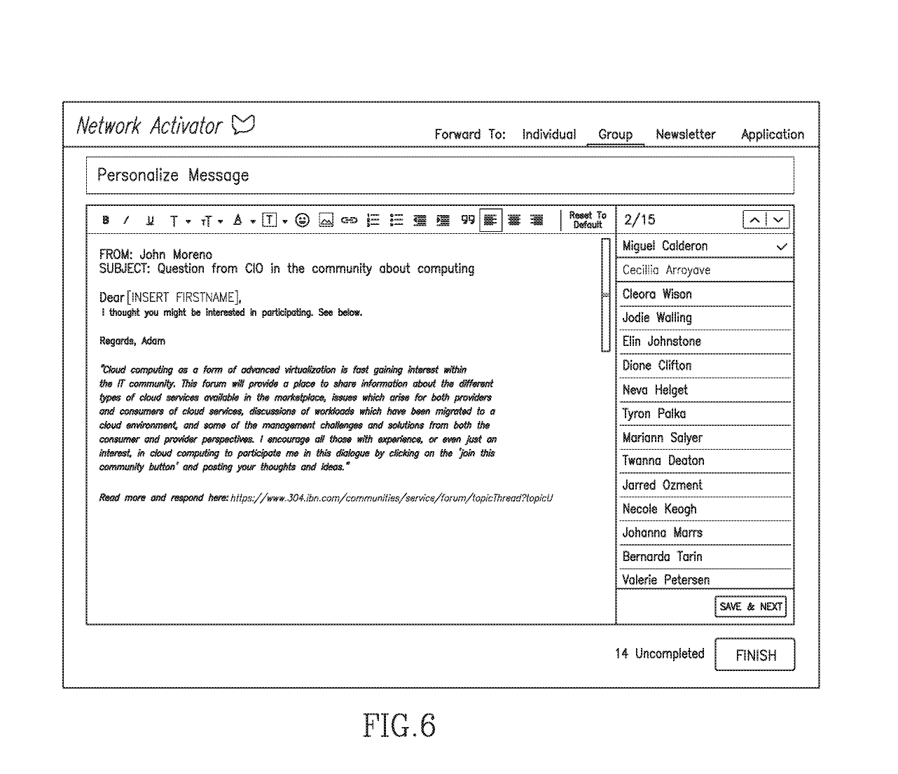

FIGS. 5 and 6, to which reference is now made illustrate the personalization of the recipients and the message. FIG. 5 illustrates details of potential recipients from a database listing. The community manager may select a recipient to whom he wishes to send a personal message (personalize box selected for ‘Tory Gelman’, as shown).

FIG. 6 illustrates a personal message, which the community manager may wish to be sent to a particular person (Miguel Calderon, in FIG. 6).

### 230 Community Manager Prepares Content for Insert to Other Applications

The community manager may edit the content, add tags, and then send content to be inserted in another application. The tags used by the community manager may also be used by the receiving application to place the information properly.

### 240 Community Manager Prepares Content for Insert to Newsletter

The community manager may edit the content and message to be sent and inserted into a draft of a newsletter. The tags may be sections of the newsletter and the newsletter may be automatically built from these forwarded content items.

210-220-230-240

Blocks 210-220-230-240 are connected to indicate that the community manager may capture information once about a webpage, and then use that information for multiple purposes (example: forward the information to a group, and add the information to a newsletter) without having the user go back to the original content to capture the information again.

### 310 Send to People, Record for Reports

Once the community manager prepares the message (steps 210,220), the system sends the messages and records the details of what was sent, including the tags.

### 330 Application Link

After the content is prepared for sending to the application (step 230) it is sent via any standard communication method between applications.

### 340 Add to Newsletter

After the content is prepared for sending to the newsletter draft (step 240) it is sent via any standard communication method between applications. It is possible for newsletters to be built and sent out of the APPLICATION system as well.

### 350 Value Report

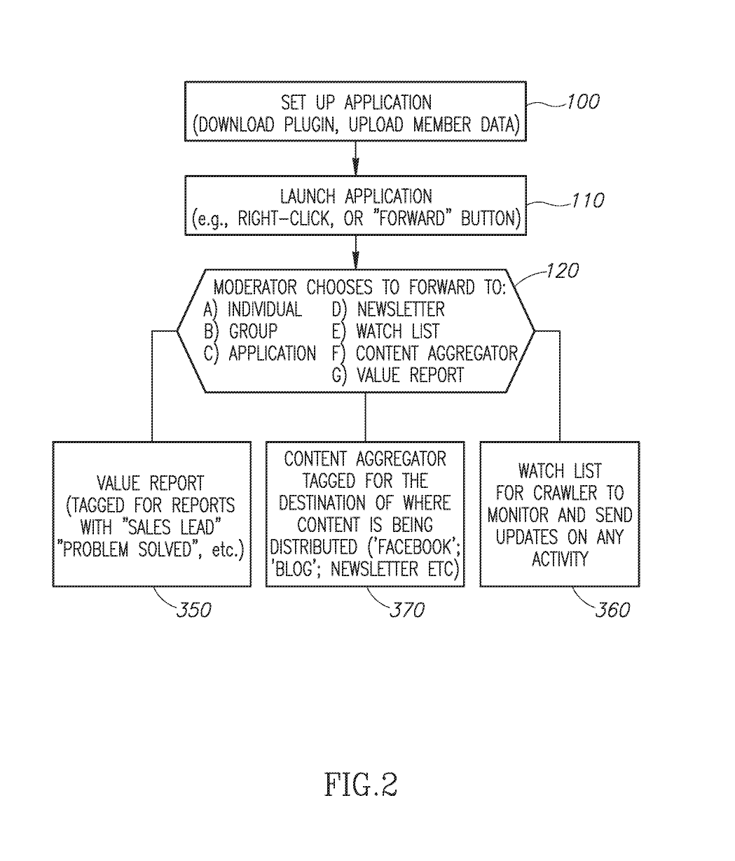

The community manager may choose (in step 120) to simply record the website information. Information, including the highlighted quotation and URL (Uniform Resource Locator), will be captured. The community manager may perform this action immediately from the web page without opening any additional application. For example, this action may be completed by selecting “Forward/ValueReport/SalesLead” (step 350, FIG. 2) from a right-click menu tree on the webpage.

### 360 Watch List

The community manager may choose (in step 120) to simply add the website URL to a watch list. The webpage will then be monitored (for example, by a web “Spider”) for any changes or additional comments (step 360, FIG. 2). The community manager or other people will be notified based on the settings in the watch list.

### 370 Content Aggregator

The community manager may choose (in step 120) to store the content to be passed on to another application later, for example, to be combined in weekly update in a blog or on a Facebook posting from the company (step 370, FIG. 2).

### DESCRIPTION OF THE EMBODIMENTS

The description that follows includes exemplary solutions that embody techniques of the present inventive subject matter. However, it is understood that the described embodiments may be practiced without these specific details. For instance, although examples refer to web pages that are forwarded using a browser plugin, embodiments may be implemented where the forward action is initiated with a forwarding capability that is embedded within a social network platform. Also, the forwarding action need not be via email, but any other common communication medium.

### Embodiment

### Social Media & Online Community Management

Companies and organizations with “social network initiatives” face operational challenges, in particular regarding their mission to encourage more activity and monitor the activity on social networks and online communities. The people (with titles such as “social media managers” or “online community managers”), even when they understand the tasks to drive and monitor the activity, face challenges related to efficiency.

For background, to understand why companies and organizations engage in these initiatives, it is helpful to consider why companies and non-profit organizations engage in “social enterprise” initiatives. Such social enterprises include Marketing/Sales, Customer Care—Community Self Help, Employee Collaboration and Call Center Team Collaboration, for example.

1) Marketing/Sales

A marketing and sales social media initiative, where the purpose of a company's social network activities is to increase sales and marketing effectiveness. The company may have private groups and “fan pages” on public social networks (Facebook, LinkedIn Group, for example) or the company may have its own private customer forums and community (build on their own, or some private labeled platform)

2) Customer Care—Community Self Help

A social network for improving customer care and reducing costs for customer care (for example, customer forums where customers solve each other's problems rather than calling in to customer care call center). Customer care employees may themselves be active on these forums, ensuring that questions are answered correctly.

3) Employee Collaboration

An internal social network for collaboration between employees . . . an “Intranet 2.0”

The purpose may be best practice sharing, simply getting to know each other, solve problems, and collaborate on sales efforts.

4) Call Center Team Collaboration

Call center employees may have their own private forums to help each other answer questions live while a call center representative is on the phone with a customer. Below, we include a separate Embodiment related to the customer care/call center environment.

In all of these cases, enterprises typically have one or more people (“community managers”) whose job it is (full time or part time) to monitor . . . and ensure the success of the social enterprise initiative

For now, let's call this person the “community manager” and consider an APPLICATION that closely follows the system described by this invention.

### Setting up the APPLICATION

There are two steps which are required to initiate the APPLICATION:

1. Prepare quick launch

2. Connect member data

### Prepare Quick Launch:

First, the community manager needs to be ready to quickly launch the application.
In the “low integration” option, the quick launch may be achieved with a browser plugin download. The icon appears on browser tool bar and the community manager may “right click” to launch the forward options from any website when he is browsing the internet.
In the “high integration” model the, launch capability may be embedded into third-party application (specifically a social network). For example, a “forward” button could appear next to the “reply” button in a message board. When the forward button is clicked the APPLICATION launches, enabling the community manager to complete moderating tasks as defined by the invented system

The APPLICATION may be integrated with a social network to automatically complete an activity (e.g., forward a message whenever someone joins a group inside a social network, or add any new member of a group to a newsletter list)

### Connect Member Data:

Secondly, the community manager will need to have all contact information (for individuals, groups and connected application) readily available at run-time so that the community manager may forward the captured information easily.
In the “low integration” implementation, a community manager (without an IT support or integration into his enterprise systems) may upload member data in standard formats (e.g., Excel or CSV) to the member database embedded in the APPLICATION.
In the “high integration” option, rather than manually uploading member data in batches, the APPLICATION could be linked real time to existing member databases [FIG. 1/Block 100].

A non-technical community manager may operate the APPLICATION without integration and IT support (browser plugin download, manual uploads of member data).

### APPLICATION in Action.

The community manager (a social media manager, for example) typical starts the work by scanning online activities (for example, all blogs, postings and “tweets” where the company name is mentioned). The community manager may start his work with a special dashboard that highlights important activities, including social comments or reputational issues. The dashboard could be linked to the APPLICATION, so quick action is enabled.

For example, the community manager sees or reads something interesting that is said about his company on a public forum. He may respond directly in the discussion of course, but more often, what is required is some other action.

If there is a particular remark within a longer posting that is interesting, the community manager may highlight the sentence and then right click and launch the APPLICATION. [FIG. 1, step 110].

The APPLICATION will display the auto-collected information and prepare a default message, including the highlighted text, image or screenshot, a link back to the page, and any other information that may be automatically captured from the page.

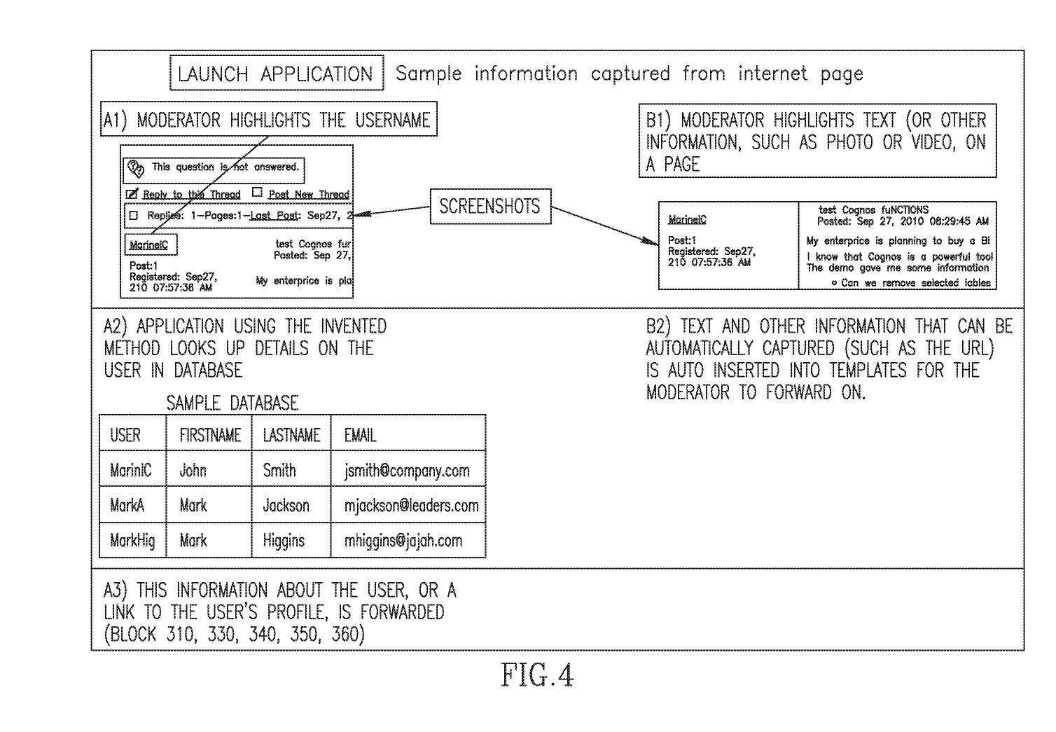

Reference is now made to FIG. 4, which illustrates examples of the use of the APPLICATION in practice.

The community manager (moderator) notices something interesting on a public forum. He may then highlight the user name (step A1) and additionally highlight text of the posting (step B1). The community manager may capture the relevant screenshots.

Then, the APPLICATION may look up details of the user in the database (step A2). Other information related to the posting, such as the URL, which may be automatically captured may be automatically inserted into a pre-formed template (step B2).

Finally, the information about the user and/or a link to the user's profile may be forwarded, as described hereinabove with reference to FIGS. 1 and 2 (step A3).

The community manager may then choose from previously built outreach templates. For example, the “Please Respond” template may include a template message from the community manager, requesting the recipient of the forwarded message to click through to the forum and respond. In this way, the community manager drives activity on the forums.

The community manager may choose (FIG. 1, step 120) from:

Forward to Individual;

Forward to Group;

Forward to Application;

Forward to Newsletter;

Forward to Content Aggregator;

Forward to Watch List.

### Forward to an Individual (FIG. 1, Step 210):

There may be a question in a customer forum from an important client that the community manager cannot answer himself, but the community manager knows an expert who may address the question. The community manager may also want to alert the sales account manager who has been working with the client who posted in the customer forum. The community manager may search for the account manager inside the APPLICATION.

The system may automatically suggest people to forward the content to but the invented system allows the human community manager to review, override, and add comments and value on top of the automated suggestions.

The community manager may add a comment of his own before forwarding. The community manager may also select (and edit) the automatically generated, message that the APPLICATION prepares by default or select a message template. The community manager may manage these templates in the APPLICATION.

The value of more efficient, personalized outreach is that social enterprise discussions are made more vibrant, as the community managers are able to engage the more senior people inside and outside the organization (those who need the gentle, personalized “push” to participate).

The community manager may add tags to the message that may be used for reporting purposes.

### Forward to a Group (FIG. 1, Step 220):

The community manager may forward a content item to a group.

The capabilities described above in “Forward to an individual” apply here as well.

If the community manager is managing an internal organization social network (Intranet 2.0, for example), his tasks may include selecting content to forward to the executive team.

If the community manager is responsible for a client community, he may want to forward some content to clients in a certain industry.

The community manager selects the group(s), selects a preformed template, edits the message and adds tags

### Forward to an Application (FIG. 1, Step 230):

In more advanced communities, where the online dialogue is already vibrant, the challenge is more about “harvesting”—making sense of everything that is being posted and using that information to advance the organization's goals.

Just as the community manager may “harvest” by forwarding user-generated-content to individuals and groups, it is also powerful to link socially generated content with other business applications.

### Examples

### Sales Software

When an online comment relates to a sales opportunity, that comment should be forwarded to the account in the sales application. The invented system enables the Community Manager to add application tags in the forwarding process that are used to categorize the forwarded content in the receiving application. So, with an API (Application Program Interface), the forwarded web content is inserted in the right area of the receiving application.

Content Management Software

Some companies, for example, in consumer electronics, spend a lot of time and money on their product manuals, to support customers and reduce inbound calls and complaints.

When customers ask questions in an online Q&A about a product, these questions (and answers) should be included in the document management/content management applications, so that the next updates of the manual will include consideration of the online Q&A.

The invented system makes it easy for the community manager to forward relevant online content to the content management software.

These are just some examples where social enterprise solutions are having a big impact with clear return on investment (ROI) by linking social discussions with business applications.

The system and APPLICATION may support multiple connected business applications and isn't hard coded into any one specific business application or social network. This is an alternative for enterprises rather than using social features that are embedded one particular application (for example, the Chatter social networking features embedded in Salesforce.com)

In an alternative embodiment, the inventive method and APPLICATION would be integrated with other applications, so that when a community manager forwards an online discussion to the other business applications, those applications will receive the messages (APIs) and incorporate them automatically, directly into their systems.

### Reports (FIG. 1, Step 330):

If there is no integration between the community manager APPLICATION and other business applications, the APPLICATION itself as part of the present invention, may produce reports, which may then be manually uploaded to other applications.

For example, a Sales Report could show all items forwarded by the community manager with the tag “sales.”

The APPLICATION records every transaction so meaningful reports that describe specifically what the community manager is doing may be generated. These go far beyond your typical social media metrics (# of views, comments, for example) to get at the value of the social enterprise initiative.

For example, how effective are the customer care forums at reducing inbound calls? The community manager of a customer care forum may add a tag (“solved problem, prevented call”) each time he spots a problem solved in the forum.

If sales people are using the APPLICATION they may record their APPLICATION actions as “lead activities”, for example.

### Newsletter (FIG. 1, Step 340)

The online activity that the community manager captures may be some very valuable insight (from a client or an employee) that should be highlighted and brought to the attention of a larger audience, but he may not want to forward it immediately (and create spam). The community manager may choose instead to add the link to a weekly newsletter. The APPLICATION will save the work of digging through the discussions each week to find the highlights for a newsletter. Instead, the community manager may automatically mark items for inclusion in the newsletter as he sees the items.

### Customer Care/Call Center Embodiment

The customer care departments of companies make use of social networks in several ways, as described herein below:

1. Customer Forums to Reduce Expensive Inbound Customer Calls.

Customers answer each other's questions in forums, so the customers do not need to call in.

In this situation, the company will usually have “community managers” whose job it is to monitor the company forums and public forums where the company's products are discussed. The community manager for the company is tasked with answering unanswered questions, dealing with unhappy customers and reporting back to the company about any interesting developments.

The inventive subject matter (and the APPLICATION described) makes the community manager's tasks easier. The community manager may use the APPLICATION to quickly classify/tag/forward a forum question as “answered” or “resolved” and add it to a knowledge database. For questions that are not resolved, the community manager may answer them himself, or forward to an expert.

Also, if hundreds of complaints come flooding in to the forums about a faulty new product launch, the community manager could forward the comments to any of the following:
Individual (product manager of the product in question);
Group (the product marketing team);
Application (production application, with the tag “urgent”—so that production is adjusted before more faulty products are delivered).

2. Online Discussions Related to Product Literature

Companies may also find value in online customer forums as a means to update their product literature and manuals. A consumer electronics company, for example, may have manuals for each electronic device, that needs to be updated frequently we each new release. The customer questions and discussions related to each electronic device may help the company efficiently update the product manuals.

The community manager's job, in this case, is to tag discussions in a way that supports the content updating system (tagging certain online discussions for example to be included in a document management system, used by the manual writers to update the next version of the manual).

The APPLICATION could produce a report, based on the tags assigned by the community manager, of customer discussions by product, to see which products are causing most problems and which manuals need updating.

3. Online Forums for the Customer Care Representatives Only (No Customers)

The customer care representatives themselves may have a private forum just for themselves to help each other answer questions. For example, a call center representative may be on the phone with a customer who has a difficult problem. The call center representative may post the question on an internal forum.

The call center may have a dedicated “community manager” of the internal forum, call center representatives themselves may “play the role” of community manager. The APPLICATION will allow the “community manager” to mark the questions as urgent and send them to a quick response team so the question will be answered while the customer is still on the phone (increasing “first call response rates,” a key metric for call centers).

One of the groups that the APPLICATION may forward to, could be a dynamic group comprised of the call center employees who are working in any given shift.

Customer care centers use other technologies of course, to communicate with customers. The community manager may review the recordings, or reports of customer interactions (IVR or customer chat sessions, for example) and forward that information using the same method as described here.

### Integrated Objectives and Measures

As the community manager forwards content, he may be prompted to enter a “reason for the activity” which is set by the administrator to be related to the objective of the community. Each activity is then recorded and becomes part of a measure. In this way the measures and objectives are embedded in the application.

### Full Automation of the Method

The method may be fully automated with no human interaction, or some human checkpoints.

Below the same steps of the method (from FIG. 1) described herein above, are described showing, with descriptions, how each step could be fully automated:

### 100 Setup APPLICATION

The APPLICATION would be embedded in one or multiple social networks, and integrated with one or multiple other business applications (such as a CRM application), so that information may be seamlessly captured and forwarded from the social networks to the business applications, based on automated decisions of the APPLICATION.

### 110 Launch APPLICATION

Rather than relying on the community manager to spot something of interest (and then do some action, such as right click to launch), the APPLICATION could automatically scan new web content and decide (based on automated analysis), which content should be forwarded (to a person, group, application, newsletter, watch list, value report, for example).

The APPLICATION may also scan the page for certain content types, such as a Username, and then do a database lookup for more profile information.

The APPLICATION may take, as input, metadata from other applications. For example, if an organization records all customer service chat records and has metadata about each session or groups of sessions, that information may feed into the APPLICATION and may be forwarded appropriately.

120 Community Manager chooses to Forward

The “automatic community manager” decides whether the information is worthy of forwarding. The algorithm, for the step of deciding, could be based on the content itself or meta-information, such as the number of views of the content, the number of subsequent comments, the number of links to the content, for example.

The algorithm could learn from the community managers' decisions over time regarding which content should be forwarded to which individuals, groups, and applications, so that the automated suggestions and decisions about the forwarding of content, will be more accurate in future

In particular this training of the algorithm would be effective when the community manager is tuning the activity streams inside a social network, whether the stream is for the community as a whole, or individualized based on profile attributes. The community manager could be tuning the optimal activity stream for one specific community member, for example, the CEO of his company.

### 210 Community Manager Prepares Individual Message

The “automated community manager” may automatically edit the message, search for recipients and add tags/categories for reporting purposes.

220 Community manager Prepares Group Message

The “automated community manager” may automatically edit the message, search for and select groups, and add tags/categories.

221 Personalize Message for some group members (Yes/No)

The “automated community manager” may decide to send customized messages to specific group members

### 222 Personalize Messages Wizard

The “automated community manager” would prepare customize messages. The recipient might even think that the message was customized for him personally, even though there was an automated decision.

[HUMAN OPTION: The application may include a human check point here, to approve the decisions made by the “automated community manager]

222a: Automatic Suggestions of people who should receive personal messages. The member database may have a Yes/No field to indicate if the member has been to an event or some other trigger for a customized message.

222c: Template flipping: The “automated community manager” would decide which templates to use for each recipient.

### 230 Community Manager Prepares Content for Insert to Other Applications

The “automated community manager” could identify content that should be pulled into other business applications, may add the appropriate tags that are readable by that application and forward the content from the social application to the other business application.

### 240 Community Manager Prepares Content for Insert to Newsletter

The “automated community manager” could identify content that should be pulled into other newsletters. The newsletters themselves may be automatically sent out.

### 310 Send to People, Record for Reports

Once the “automated community manager” prepares the message (210,220), the system could send the messages and record the details of what was sent, including the tags. The message could be inserted into the social network activity feeds of the recipients.

### 330 Application Link

After the content is prepared for sending to the application (230) it may be sent via any standard communication method between applications.

### 340/370 Add to Newsletter or Content Aggregator

After the content is prepared for sending to the newsletter draft (240) it is sent via any standard communication method between applications. It is possible for newsletters or content updates to any other applications (using a content aggregator) to be built and sent out of the APPLICATION system as well.

### 350 Value Report

The “automated community manager” may choose (in step 120) based on content and meta-content analysis to simply record the website information. Information, including the highlighted quotation and URL, will be captured. For example, this action may be completed by the “automated community manager” tagging the content as “Forward/ValueReport/SalesLead”

### 360 Watch List

The “automated community manager” may choose (in step 120) to simply add the website URL to a watch list. The webpage will then be monitored (for example, by a web “Spider”) for any changes or additional comments. The “automated community manager” or actual people will be notified based on the settings in the watch list. The automated community manager may then take further action on the new content that has been identified in the watch list.

### Improving the Automation Over Time

The decision processes (the brain) of the “automated community manager” may be modified or self-learnt, based on responses to the content that was forwarded and other information.

Additional features and embodiments of the invention will now be described.

### Email Forwarding

The present invention differs from the prior art in that it enables the community manager (user) to forward content via email (or via other channels) as part of the method described hereinabove, beginning with the user grabbing or curating content from any website.

Regarding message forwarding, the present invention includes the feature of following abilities (see FIGS. 5 & 6, which show screenshots from an application relating to “personalized” messaging).

The present invention has the capability to select individuals in a group who will receive an altered version of the message. Furthermore, the present invention may comprise a “wizard” to edit the different messages for people in the groups, including editing the content to be forwarded, and the value-added commentary from the community manager, for example.

### Online Forum Posting

In the present invention the community manager has the ability to forward an online forum message (however it is displayed) to different people, groups, and applications.

Furthermore, in the present invention, it is possible to forward the message back into the social network activity stream and the messages would be customized with edits of the community manager. Individual activity streams could have different messages based on the community manager decisions using the invented method.

### Content Curation

The present invention may also be considered as an example of content curation, where the community manager acts as a curator. As curator, the community manager may carry out a number of functions, such as finding interesting content, adding his own commentary and tags and sending the content or variations of the content to people or to other applications.

### Social Network “Node”

The community manager may also be considered as a “Node” in the language of social network analysis. The present invention enables the community manager ‘Node’ to create, strengthen and exploit the connections (or “ties”) he has with other members of the community, by sending content to the other nodes in the social network. Since the present invention also supports connections to anyone inside or outside the social networks, the system may also serve to create new connections.

### Neural Networks and Connectionism

By assigning more weight to the activities of the community managers, the present invention improves the algorithm of determining relevance of content to individuals, and the algorithm for making suggestions to connect different individuals in a network.

Most social network algorithms rely heavily on the reactions of others to determine the value of a piece of content (“likes” or “follows”). The present invention allows for higher weighting to be assigned to specific Nodes (community managers). The present invention may also be used to allow a content creator to rate his own content, and have that rating influence the relevant algorithms. The content creator himself may vote on how important his own content is, and have this self-assessing vote count in the automated algorithms.

Irrespective of how the algorithm functions and irrespective of how Neural Networks or other systems create suggestions for communication between nodes, the present invention provides for a human checkpoint in the automated process. In a scenario where a system automatically passes information between nodes in a network and where the information is first passed to a human operator (who views all of the information on a dashboard), the human community moderator may approve, edit, or reroute, the information. Based on the human intervention, the automated system may learn and improve its decision making process and its configurations.

### Machine Learning

The present invention may improve a machine learning how best to link content and people in a social network. For example, if the content manager forwards content to a recipient, who clicks through to read the full item, the machine can learn to value this connection.

Also, if the recipient spends a long time reading and interacting with the forwarded item, it will learn that this content is relevant to the recipient.

The machine may then adjust the tasks or algorithm for forwarding materials, for example.

The machine may also learn from the intermediary role of the community manager who reviews the material for forwarding and accepts, adjusts or rejects the information.

### Example of Invented System+Machine Learning (New Member in Social Network)

A new community member receives a “welcome to the community” automated response which includes a prompt to fill out more details in a profile.

Generally, when the new member completes some “interests” in his profile, this may trigger an auto suggested response, such as “you may be interested in these resources, based on your interests”, for example.

However, in the present invention, the auto response first goes into a queue for the community manager, who may override, or add additional suggestions in the outreach.

For example, because the community members is in industry X or geography Y, the community manager may combine that information with the interests to adjust the recommendations, or reprioritize the list.

The community manager may also personalize the message based on a relationship with the community member. This latter feature cannot be automated by the machine.

The community manager may provide some tags specifically for the machine learning to improve in the future.

How the Present Invention Differs from Social Network Capabilities

Social platforms today may allow the community manager to highlight, comment on or “like” a particular content item. Some social networks allow the community manager to move a comment from one area of the network to another. The present invention provides more power to the community manager, allowing him to:
forward the content and engage the community through private outreach, inside or outside the specific social network platform, (via private email, or private messaging for example.)
influence the social activity stream inside a social network, so that the actions of the community manager (for example, a private “like” or a private mention of someone's name)—change the algorithm of the activity stream. The activity stream and updates to specific members, and the general community activity stream are thus impacted by the actions (both public and private) of the community manager.
pass the information to other business applications. In particular, the present invention allows “any to any” connections. The “right click” capability to forward information works on any web-based application or content page and the information may be forwarded into any linked application. In this way, the present invention serves as social middleware, delivering relevant social content to any applications.

The present invention tackles three problems:

Easy, Powerful Website Forwarding

Generally, today, an interesting URL or a captured screen may be sent via email. Even if the browser has an automated “send” capability” there is no ability to record the forwarded information, to add a comment to it before it is forwarded. In contrast, the present invention allows for the forwarding of information and adding comment. The present invention is unique in that it can work with any browser.

Better Online Community Management

There is no known solution specifically for community managers to efficiently outreach and engage with members.

Flexible “Social Middleware”

To link activities on a social platform to those on other business applications (for example, sales application), would require a complicated systems integration project. In contrast, the present invention enables the community manager to “curate” and select content from the social network, and efficiently pass it to any business application with a simple API (Application Program Interface). As a browser based plugin, the social middleware may connect content (and meta data) from any web-based application to any other application.

It will be appreciated that the present invention is not limited by what has been described hereinabove and that numerous modifications, all of which fall within the scope of the present invention, exist. Rather the scope of the invention is defined by the claims, which follow:

1. A method for managing online information by a community manager comprising the steps of:
capturing information from an online source;
adding value to said information; and
forwarding the information together with said added value.

2. The method of claim 1, wherein said step of forwarding comprises the step of:
using pre-formed message templates to forward to any of a group including at least one individual, at least one other community manager, at least one newsletter, at least one content, collecting repository and at least one software application.

3. The method of claim 1, wherein said step of adding value comprises the steps of classifying, adding tags and commenting on said online information.

4. The method of claim 1, further comprising the steps of:
tracking and reporting the activity of the community manager.

5. The method of claim 1, wherein said step of capturing information is triggered by activity on the web page, said activity comprising at least one of a group of activities including reaching a certain number of views or comments.

6. The method of claim 1, wherein said step of forwarding comprises the step of:
creating reports, said reports comprising at least one of a group of reports including ideas developed by community, reputational issues, and the number of sales leads forwarded by the community manager.

7. The method of claim 1, wherein at least one of said steps of capturing, adding value and forwarding are at least partially automated.

8. The method of claim 1, wherein said step of capturing information comprises the steps of:
adding the website Uniform Resource Locator (URL) address to a watch list; and
storing the information.

9. The method of claim 1, wherein said step of capturing information comprises the steps of:
capturing the name or unique identification of the author of the content and looking up related information associated with the author in a database.

10. The method of claim 1, further comprising the steps of:
said community manager launching a software application and uploading a database of members.

11. The method of claim 1, further comprising the steps of:
said community manager scanning online activity sites; and
selecting text from information appearing on said online activity sites.

12. The method of claim 1, wherein said step of forwarding comprises the step of:
selecting individuals from within a database who will receive the information together with the added value.

13. The method of claim 1, wherein said website information is an online forum message appearing on a message board and further comprising the steps of:
editing said message and
forwarding the message back into the message boards or to another activity stream or to an email.

14. The method of claim 13, wherein said editing comprises at least one of the steps of adding commentary and adding tags to content to the message.

15. The method of claim 7, further comprising the step of said community manager intervening in said at least partially automated system, said intervention comprising at least one of steps of approving, editing and rerouting information.

16. The method of claim 15, further comprising the step of said at least partially automated system learning from said step of intervening and amending its decision making process.

17. A method for managing online information by a plurality of community managers comprising the steps of:
each of said plurality of community managers performing at least one activity on at least one online source;
analyzing the said at least one activity by each of said plurality of community managers; and
preparing a report based on said step of analyzing.

18. The method of claim 17, wherein said step of performing at least one activity comprises the steps of:
capturing information from a website or social media page;
adding value to said information; and
forwarding the information together with said added value using pre-formed message templates to any of a group including at least one individual, at least one other community manager, at least one newsletter, at least one content collecting repository and at least one software application.
